(19) United States
(12) Patent Application Publication
(10) Pub. No.: US 2025/0297889 A1
(43) Pub. Date: Sep. 25, 2025

(54) Measurement Method, Measurement Apparatus, Measurement System, And Non-Transitory Computer-Readable Storage Medium Storing Measurement Program

(71) Applicant: SEIKO EPSON CORPORATION, Tokyo (JP)

(72) Inventor: Yoshihiro KOBAYASHI, Komagane (JP)

(21) Appl. No.: 19/087,764

(22) Filed: Mar. 24, 2025

(30) Foreign Application Priority Data
Mar. 25, 2024 (JP) 2024-048338

(51) Int. Cl. G01H 13/00; G01C 21/16; G01H 1/06; G01M 5/00; G01P 7/00

(52) U.S. Cl. CPC G01H 13/00; G01C 21/16; G01H 1/06; G01M 5/0008; G01P 7/00

(57) ABSTRACT

A measurement method includes: an observation data acquisition step of acquiring observation data output from an observation apparatus that observes an observation point of a bridge, the observation data including a response to an action of a railway vehicle traveling on the bridge on the observation point; a fundamental frequency calculation step of calculating, based on first measurement data based on the observation data, a fundamental frequency of deflection repeatedly generated at the bridge due to the traveling of the railway vehicle; a filter processing step of performing filter processing on the first measurement data using a filter having a passband variably set according to the fundamental frequency to generate second measurement data; and an integration processing step of performing integration processing on the second measurement data to generate third measurement data.

The present application is based on, and claims priority from JP Application Serial Number 2024-048338, filed Mar. 25, 2024, the disclosure of which is hereby incorporated by reference herein in its entirety.

### BACKGROUND

### 1. Technical Field

The present disclosure relates to a measurement method, a measurement apparatus, a measurement system, and a non-transitory computer-readable storage medium storing a measurement program.

### 2. Related Art

JP-A-2019-049095 discloses an acceleration sensor mounted on a railway bridge and a deflection measurement apparatus that sets output of the acceleration sensor when the railway bridge is in an unloaded state as a zero point of an acceleration, corrects the zero point of the acceleration output from the acceleration sensor when the railway bridge is in a loaded state, and applies double integration, Bayesian estimation, a Kalman filter, or the like after the zero point correction to prevent drift and estimate a deflection amount of the railway bridge.

However, in FIG. 3C in JP-A-2019-049095, displacement in a section where the railway bridge is in the loaded state is higher than that in a section where the railway bridge is in the unloaded state, and it is clear that an expected displacement waveform is a waveform in which the displacement in the section where the railway bridge is in the loaded state is lower than that in the section where the railway bridge is in the unloaded state. This is similar to a result where a signal component in a low-frequency range of the displacement waveform is dampened together with a drift component in the low-frequency range. Therefore, in a deflection amount estimation method using the deflection measurement apparatus disclosed in JP-A-2019-049095, since the component in the low-frequency range of the displacement waveform is also dampened together with the drift, it may not be possible to estimate an original displacement amplitude with high accuracy.

### SUMMARY

An aspect of a measurement method according to the disclosure includes:
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.

An aspect of a measurement apparatus according to the disclosure includes:
an observation data acquisition unit configured to acquire observation data output from an observation apparatus that observes an observation point of a bridge, the observation data including a response to an action of a railway vehicle traveling on the bridge on the observation point;
a fundamental frequency calculation unit configured to calculate, based on first measurement data based on the observation data, a fundamental frequency of deflection repeatedly generated at the bridge due to the traveling of the railway vehicle;
a filter processing unit configured to perform filter processing on the first measurement data using a filter having a passband variably set according to the fundamental frequency to generate second measurement data; and
an integration processing unit configured to perform integration processing on the second measurement data to generate third measurement data.

An aspect of a measurement system according to the disclosure includes:
the aspect of the measurement apparatus; and
the observation apparatus.

An aspect of a non-transitory computer-readable storage medium storing a measurement program according to the disclosure causes a computer to execute
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.

### BRIEF DESCRIPTION OF THE DRAWINGS

FIG. 1 shows a configuration example of a measurement system.

FIG. 2 is a cross-sectional view of a superstructure in FIG. 1 taken along line A-A.

FIG. 3 shows an acceleration detected by an acceleration sensor.

FIG. 4 shows an example of an acceleration α(t) when a railway vehicle travels on a bridge.

FIG. 5 shows displacement u(t) obtained by performing double integration on the acceleration α(t).

FIG. 6 shows examples of displacement waveforms of the bridge when a passing time tₛ differs.

FIG. 7 shows frequency spectrum obtained by performing fast Fourier transform on the displacement waveforms shown in FIG. 6.

FIG. 8 shows examples of displacement waveforms of the bridge when the number of cars differs.

FIG. 9 shows frequency spectrum obtained by performing fast Fourier transform on the displacement waveforms shown in FIG. 8.

FIG. 10 shows examples of displacement waveforms of the bridge when a bridge length differs.

FIG. 11 shows frequency spectrum obtained by performing fast Fourier transform on the displacement waveforms shown in FIG. 10.

FIG. 12 shows an example of a gain-frequency characteristic of a high-pass filter.

FIG. 13 shows an example of the acceleration α(t).

FIG. 14 shows frequency spectrum obtained by performing fast Fourier transform on the acceleration α(t) shown in FIG. 13.

FIG. 15 shows a speed v(t) obtained by integrating the acceleration after filter processing.

FIG. 16 shows the displacement u(t) obtained by performing double integration on the acceleration after the filter processing.

FIG. 17 shows an example of the acceleration α(t).

FIG. 18 shows frequency spectrum obtained by performing fast Fourier transform on the acceleration α(t) shown in FIG. 17.

FIG. 19 shows a relationship between the acceleration α(t) and the passing time tₛ.

FIG. 20 shows an example of a length L_{C}(Cₘ) and an axle-to-axle distance La(a_{w}(Cₘ, n) of a car.

FIG. 21 shows an acceleration α_{LPF}(t) obtained by performing low-pass filter processing on the acceleration α(t) in FIG. 19.

FIG. 22 shows an example of a gain-frequency characteristic of a high-pass filter.

FIG. 23 shows frequency spectrum obtained by performing fast Fourier transform on the acceleration after performing filter processing on the acceleration α(t) in FIG. 13 using the high-pass filter.

FIG. 24 shows the speed v(t) obtained by integrating the acceleration after performing the filter processing on the acceleration α(t) in FIG. 13 using the high-pass filter having the characteristic in FIG. 22.

FIG. 25 shows the displacement u(t) obtained by performing double integration on the acceleration after performing the filter processing on the acceleration α(t) in FIG. 13 using the high-pass filter having the characteristic shown in FIG. 22.

FIG. 26 is a flowchart showing an example of a procedure of a measurement method in a first embodiment.

FIG. 27 is a flowchart showing an example of a procedure of a fundamental frequency calculation step.

FIG. 28 is a flowchart showing another example of the procedure of the fundamental frequency calculation step.

FIG. 29 is a flowchart showing another example of the procedure of the fundamental frequency calculation step.

FIG. 30 shows a configuration example of a sensor, a measurement apparatus, and a monitoring apparatus.

FIG. 31 is a flowchart showing an example of a procedure of a measurement method in a second embodiment.

FIG. 32 shows a configuration example of a measurement apparatus in the second embodiment.

### DESCRIPTION OF EMBODIMENTS

Hereinafter, preferred embodiments of the disclosure will be described in detail with reference to the drawings. The embodiments to be described below do not unduly limit contents of the disclosure described in the claims. Not all configurations described below are necessarily essential components of the disclosure.

### 1. First Embodiment

### 1-1. Configuration of Measurement System

A weight of a railway vehicle passing a bridge is large and can be measured using BWIM. BWIM is an abbreviation for bridge weigh-in-motion, and is a technique for measuring the weight, the number of axles, and the like of the railway vehicle passing the bridge by treating the bridge as a “scale” and measuring deformation of the bridge. The bridge that can analyze the weight of the passing railway vehicle based on a response such as deformation or strain has a structure in which the BWIM functions, and a BWIM system that applies a physical process between an action on the bridge and the response enables the measurement of the weight of the passing railway vehicle.

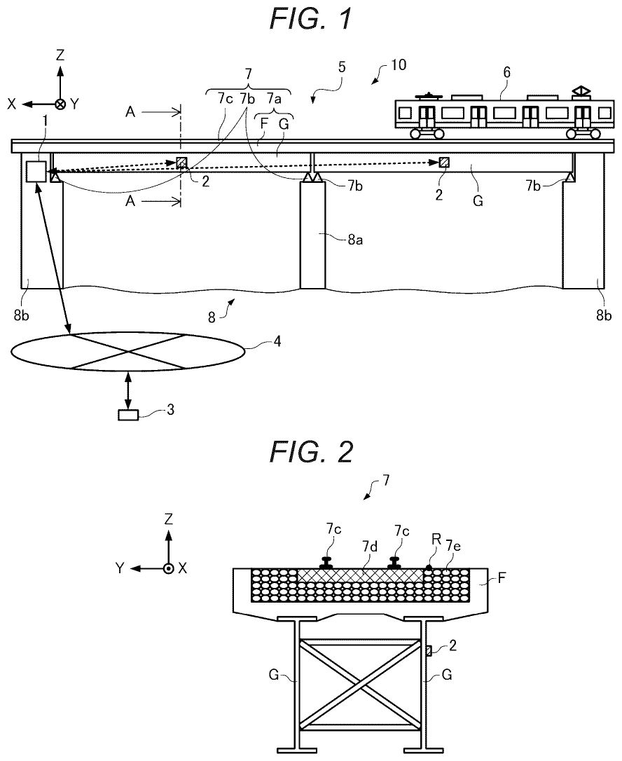

FIG. 1 shows an example of a measurement system according to an embodiment. As shown in FIG. 1, a measurement system 10 according to the embodiment includes a measurement apparatus 1, and at least one sensor 2 provided at a bridge 5. The measurement system 10 may further include a monitoring apparatus 3.

The bridge 5 includes a superstructure 7 and a substructure 8. FIG. 2 is a cross-sectional view of the superstructure 7 taken along line A-A in FIG. 1. As shown in FIGS. 1 and 2, the superstructure 7 includes a bridge deck 7a including a deck slab F, a main girder G, a cross girder (not shown), and the like, a bearing 7b, a rail 7c, a tie 7d, and a ballast 7e. As shown in FIG. 1, the substructure 8 includes a bridge pier 8a and a bridge abutment 8b. The superstructure 7 is a structure that spans across the bridge abutment 8b and the bridge pier 8a adjacent to each other, two adjacent bridge abutments 8b, or two adjacent bridge piers 8a. Both ends of the superstructure 7 are located at positions of the bridge abutment 8b and the bridge pier 8a adjacent to each other, at positions of the two adjacent bridge abutments 8b, or at positions of the two adjacent bridge piers 8a.

When a railway vehicle 6 enters the superstructure 7 of the bridge 5, the superstructure 7 deflects due to a load of the railway vehicle 6, and since the railway vehicle 6 has a plurality of coupled cars, the deflection of the superstructure 7 is periodically repeated as each car passes.

The measurement apparatus 1 and each sensor 2 are coupled by, for example, a cable (not shown), and communicate with each other via a communication network such as a CAN. CAN is an abbreviation for a controller area network. Alternatively, the measurement apparatus 1 and each sensor 2 may communicate with each other via a wireless network.

Each sensor 2 outputs observation data including a physical quantity generated when the railway vehicle 6 travels on the bridge 5. In the embodiment, each sensor 2 is an acceleration sensor and outputs acceleration data including an acceleration generated when the railway vehicle 6 travels on the bridge 5. Each sensor 2 may be, for example, a quartz crystal acceleration sensor or a MEMS acceleration sensor. MEMS is an abbreviation for micro electro mechanical systems.

In the embodiment, each sensor 2 is provided at a central portion in a longitudinal direction of the superstructure 7 of the bridge 5, specifically, at a central portion in a longitudinal direction of the main girder G. However, each sensor 2 only needs to be capable of detecting the acceleration generated due to the traveling of the railway vehicle 6, and an installation position thereof is not limited to the central portion of the superstructure 7. When each sensor 2 is provided at the deck slab F of the superstructure 7, the sensor 2 may be broken due to the traveling of the railway vehicle 6 and measurement accuracy may be affected due to local deformation of the bridge deck 7a, and thus each sensor 2 is provided at the main girder G of the superstructure 7 in the example in FIGS. 1 and 2.

The deck slab F, the main girder G, and the like of the superstructure 7 deflect in a vertical direction due to the load of the railway vehicle 6 passing the bridge 5. Each sensor 2 detects an acceleration of the deflection of the deck slab F and the main girder G due to the load of the railway vehicle 6 passing the bridge 5.

Based on the acceleration data output from each sensor 2, the measurement apparatus 1 calculates displacement of the bridge 5 when the railway vehicle 6 passes the bridge 5. The displacement of the bridge 5 is, specifically, displacement of the superstructure 7 to be measured. The measurement apparatus 1 is provided at, for example, the bridge abutment 8b.

The measurement apparatus 1 and the monitoring apparatus 3 can communicate with each other via, for example, a wireless network of a mobile phone and a communication network 4 such as the Internet. The measurement apparatus 1 transmits, to the monitoring apparatus 3, measurement data including the displacement of the bridge 5 when the railway vehicle 6 passes the bridge 5. The monitoring apparatus 3 may store the measurement data in a storage apparatus (not shown) and perform processing such as monitoring of the railway vehicle 6 and abnormality determination of the superstructure 7 based on the displacement of the bridge 5 contained in the measurement data.

In the embodiment, the bridge 5 is a railway bridge such as a steel bridge, a girder bridge, or an RC bridge. RC is an abbreviation for reinforced-concrete.

As shown in FIG. 2, in the embodiment, an observation point R is set in association with the sensor 2. In the example in FIG. 2, the observation point R is set at a position on a surface of the superstructure 7 located vertically above the sensor 2 provided at the main girder G. That is, the sensor 2 is an observation apparatus that observes the observation point R, detects a physical quantity that is a response to an action of a plurality of parts of the railway vehicle 6 traveling on the bridge 5 on the observation point R, and outputs observation data including the detected physical quantity. For example, each of the plurality of parts of the railway vehicle 6 is an axle or a wheel, and is hereinafter assumed to be the axle. In the embodiment, each sensor 2 is an acceleration sensor and detects an acceleration as the physical quantity. The sensor 2 only needs to be provided at a position where the acceleration generated at the observation point R due to the traveling of the railway vehicle 6 can be detected, and is desirably provided at a position close to vertically above the observation point R.

The number and the installation position of the sensor 2 are not limited to the example shown in FIGS. 1 and 2, and various modifications can be made.

Based on the observation data output from the sensor 2, the measurement apparatus 1 acquires an acceleration in a direction intersecting a surface of the superstructure 7 of the bridge 5 where the railway vehicle 6 travels. The surface of the superstructure 7 where the railway vehicle 6 travels is defined by a direction in which the railway vehicle 6 travels, that is, an X direction that is the longitudinal direction of the superstructure 7, and a direction orthogonal to the direction in which the railway vehicle 6 travels, that is, a Y direction that is a width direction of the superstructure 7. Since the observation point R deflects in a direction orthogonal to the X direction and the Y direction due to the traveling of the railway vehicle 6, it is desirable that the measurement apparatus 1 acquires an acceleration in the direction orthogonal to the X direction and the Y direction, that is, a Z direction that is a normal direction of the deck slab F, in order to accurately calculate magnitude of the acceleration of the deflection.

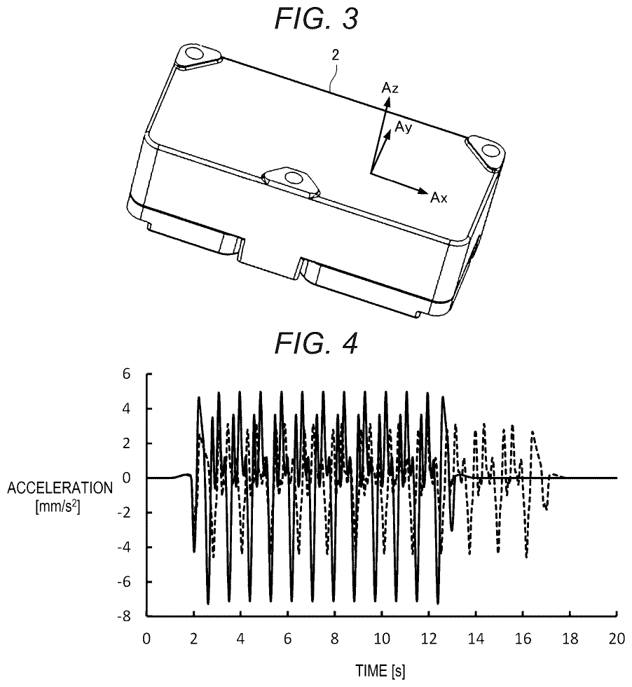

FIG. 3 shows the acceleration detected by the sensor 2. The sensor 2 is an acceleration sensor that detects the acceleration generated in each of three axes orthogonal to one another.

In order to detect the acceleration of the deflection of the observation point R caused by the traveling of the railway vehicle 6, the sensor 2 is provided such that one of an x-axis, a y-axis, and a z-axis, which are three detection axes, is in a direction intersecting the X direction and the Y direction. Since the observation point R deflects in the direction orthogonal to the X direction and the Y direction, in order to accurately detect the acceleration of deflection, ideally, the sensor 2 is provided such that one axis is aligned with the Z direction orthogonal to the X direction and the Y direction, that is, the normal direction of the deck slab F.

However, when the sensor 2 is provided at the superstructure 7, an installation location may be inclined. In the measurement apparatus 1, even when one of the three detection axes of the sensor 2 is not aligned with the normal direction of the deck slab F, since the axis is substantially oriented in the normal direction, an error is small and thus can be ignored. Even when one of the three detection axes of the sensor 2 is not aligned with the normal direction of the deck slab F, the measurement apparatus 1 can correct a detection error caused by inclination of the sensor 2 using a three-axis combined acceleration obtained by combining accelerations in the x-axis, the y-axis, and the z-axis. Alternatively, the sensor 2 may be a uniaxial acceleration sensor that at least detects an acceleration generated in a direction substantially parallel to the vertical direction or an acceleration in the normal direction of the deck slab F.

Hereinafter, details of a measurement method according to the embodiment performed by the measurement apparatus 1 will be described.

### 1-2. Details of Measurement Method

When the railway vehicle 6 travels on the bridge 5, an acceleration having periodicity in a gravitational acceleration direction is generated at the observation point R due to a load of each axle of the railway vehicle 6. The sensor 2 detects the acceleration as an acceleration α(k) in the z-axis direction, and outputs the acceleration data including the acceleration α(k) in time series. Here, k is a sample number. When a sample time interval is ΔT, the time series of the acceleration α(k) is converted into an acceleration α(t) having a time t as a variable, where the time t=kΔT. FIG. 4 shows two examples of the acceleration α(t) when the railway vehicle 6 travels on the superstructure 7 of the bridge 5. In FIG. 4, a solid line and a broken line both indicate the acceleration α(t) when the railway vehicle 6 travels at a constant traveling speed, and since the solid line corresponds to a higher traveling speed of the railway vehicle 6 than the broken line, a period during which the acceleration α(t) vibrates is shorter.

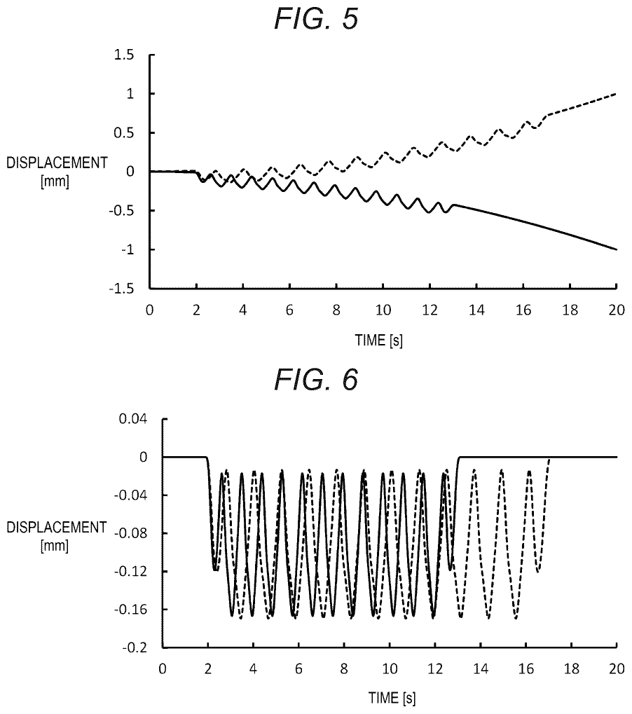

A speed v(t) of the displacement of the bridge 5 is obtained by integrating the acceleration α(t) and displacement u(t) of the bridge 5 is obtained by performing double integration on the acceleration α(t), and the speed v(t) and the displacement u(t) drift due to an integration error occurring due to an offset component and a noise component in the acceleration α(t). In particular, since the integration error increases due to the double integration, the displacement u(t) greatly drifts. FIG. 5 shows the displacement u(t) obtained by performing double integration on two accelerations α(t) shown in FIG. 4. In FIG. 5, a solid line indicates the displacement u(t) obtained by performing double integration on the acceleration α(t) indicated by the solid line in FIG. 4, and a broken line indicates the displacement u(t) obtained by performing double integration on the acceleration α(t) indicated by the broken line in FIG. 4.

Since the offset component and the noise component causing the drift are in a low-frequency range, high-pass filter processing is performed on the acceleration α(t) in order to reduce such drift. A cutoff frequency of a high-pass filter is set to a frequency lower than a minimum frequency of a signal component necessary for measurement in the acceleration α(t) such that the necessary signal component is not reduced by the high-pass filter processing. For example, a lowest frequency of the signal component necessary for measurement is a fundamental frequency f_{c} of deflection repeatedly generated at the bridge 5 due to traveling of the railway vehicle 6. In general, the fundamental frequency f_{c} is a signal component having maximum intensity in the acceleration α(t).

When second to n-th harmonic signal components, which are frequencies 2 to n times the fundamental frequency f_{c}, are signal components necessary for measurement, a signal component or a noise component having a frequency higher than n times the fundamental frequency f_{c} is not the signal component necessary for measurement. Here, n is a predetermined integer of 2 or more, and is set to an appropriate value in advance according to a purpose of measurement. For example, n may be set to 5. A natural resonance frequency of a structure of the bridge 5 may be a signal component in a high-frequency range that is not the signal component necessary for measurement. In order to reduce the signal component and the noise component in the high-frequency range without reducing the n-th harmonic component, low-pass filter processing may be performed on the acceleration α(t). When the high-pass filter processing and the low-pass filter processing are performed, band-pass filter processing is performed as a result. Alternatively, the band-pass filter processing may be directly performed on the acceleration α(t).

Meanwhile, a waveform of the displacement of the bridge 5 when the railway vehicle 6 travels on the bridge 5 changes depending on a passing time tₛ that is a time required for the railway vehicle 6 to pass the superstructure 7 of the bridge 5, the number of cars C_{T} of the railway vehicle 6, a bridge length L_{B}, and the like. The bridge length L_{B} is a length of the bridge 5, and in the embodiment, is a distance between an entry end and an exit end of the superstructure 7. For example, when the bridge 5 includes a plurality of superstructures 7, the bridge length L_{B} is a distance between the entry end and the exit end of each superstructure 7.

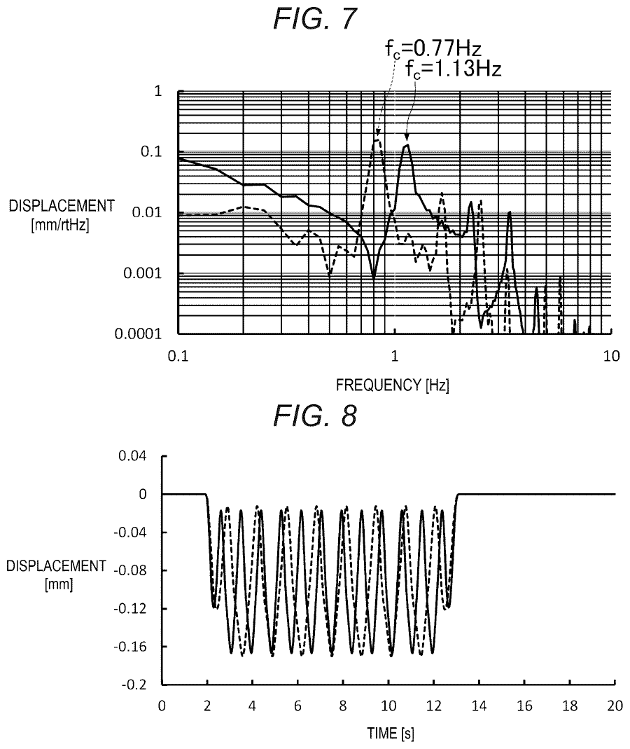

FIG. 6 shows two examples of displacement waveforms of the bridge 5 when the passing time tₛ differs. In FIG. 6, a solid line is a displacement waveform when the passing time tₛ is 11 seconds, the number of cars C_{T} is 12, and the bridge length L_{B} is 12 m, and a broken line is a displacement waveform when the passing time tₛ is 15 seconds, the number of cars C_{T} is 12, and the bridge length L_{B} is 12 m. FIG. 7 shows frequency spectrum obtained by performing fast Fourier transform on the two displacement waveforms shown in FIG. 6. In FIG. 7, a solid line is frequency spectrum obtained by performing fast Fourier transform on the displacement waveform indicated by the solid line in FIG. 6, and a broken line is frequency spectrum obtained by performing fast Fourier transform on the displacement waveform indicated by the broken line in FIG. 6. As shown in FIG. 6, since the solid line exhibits a shorter vibration cycle of the displacement waveform as compared to the broken line, as shown in FIG. 7, the fundamental frequency f_{c} or a frequency that is 2 to n times the fundamental frequency f_{c} is higher for the solid line than for the broken line.

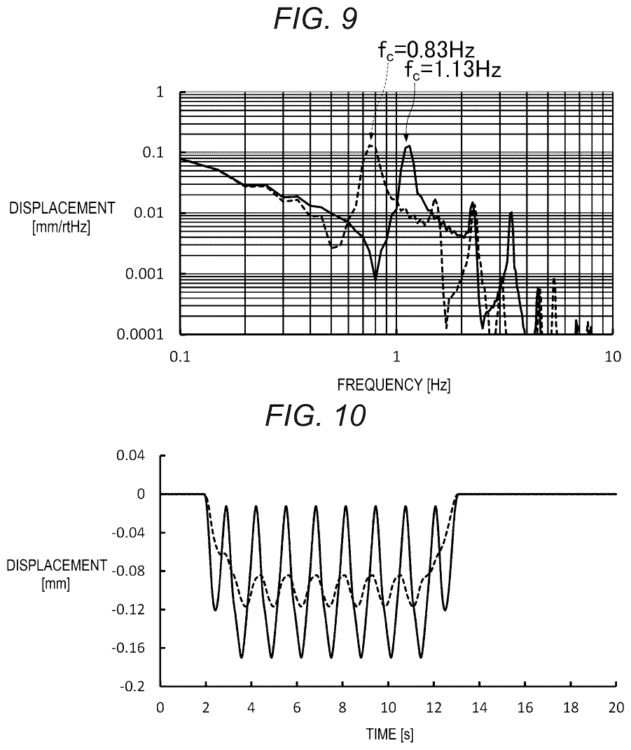

FIG. 8 shows two examples of displacement waveforms of the bridge 5 when the number of cars C_{T} differs. In FIG. 8, a solid line is a displacement waveform when the passing time tₛ is 11 seconds, the number of cars C_{T} is 12, and the bridge length L_{B} is 12 m, and a broken line is a displacement waveform when the passing time tₛ is 11 seconds, the number of cars C_{T} is 8, and the bridge length L_{B} is 12 m. FIG. 9 shows frequency spectrum obtained by performing fast Fourier transform on the two displacement waveforms shown in FIG. 8. In FIG. 9, a solid line is frequency spectrum obtained by performing fast Fourier transform on the displacement waveform indicated by the solid line in FIG. 8, and a broken line is frequency spectrum obtained by performing fast Fourier transform on the displacement waveform indicated by the broken line in FIG. 8. As shown in FIG. 8, since the solid line exhibits a shorter vibration cycle of the displacement waveform as compared to the broken line, as shown in FIG. 9, the fundamental frequency f_{c} or the frequency that is 2 to n times the fundamental frequency f_{c} is higher for the solid line than for the broken line.

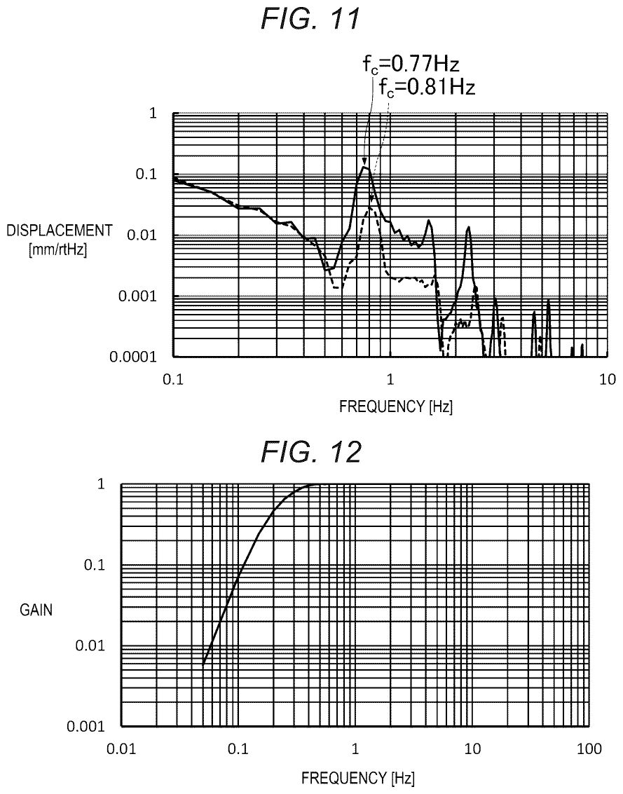

FIG. 10 shows two examples of displacement waveforms of the bridge 5 when the bridge length L_{B} differs. In FIG. 10, a solid line is a displacement waveform when the passing time tₛ is 11 seconds, the number of cars C_{T} is 8, and the bridge length L_{B} is 12 m, and a broken line is a displacement waveform when the passing time tₛ is 11 seconds, the number of cars C_{T} is 8, and the bridge length L_{B} is 24 m. FIG. 11 shows frequency spectrum obtained by performing fast Fourier transform on the two displacement waveforms shown in FIG. 10. In FIG. 11, a solid line is frequency spectrum obtained by performing fast Fourier transform on the displacement waveform indicated by the solid line in FIG. 10, and a broken line is frequency spectrum obtained by performing fast Fourier transform on the displacement waveform indicated by the broken line in FIG. 10. As shown in FIG. 10, since the broken line exhibits a slightly shorter vibration cycle of the displacement waveform as compared to the solid line, as shown in FIG. 11, the fundamental frequency f_{c} or the frequency that is 2 to n times the fundamental frequency f_{c} is slightly higher for the broken line than for the solid line.

In this way, the fundamental frequency f_{c} or the frequency that is 2 to n times the fundamental frequency f_{c} changes depending on the passing time tₛ, the number of cars C_{T}, the bridge length L_{B}, and the like. Although the bridge length L_{B} does not change with respect to the bridge 5 to be measured, when a plurality of different types of railway vehicles 6 are allowed to travel on the bridge 5, the passing time tₛ and the number of cars C_{T} may change. Therefore, it is conceivable to perform filter processing using a high-pass filter or a band-pass filter such that a range of the fundamental frequency f_{c} determined by ranges of the passing time tₛ and the number of cars C_{T} assumed for the bridge 5 to be measured is entirely within a passband. Similarly, it is conceivable to perform filter processing using a low-pass filter or a band-pass filter such that a range of the frequency that is n times the fundamental frequency f_{c} determined by the ranges of the passing time tₛ and the number of cars C_{T} assumed for the bridge 5 to be measured is entirely within the passband.

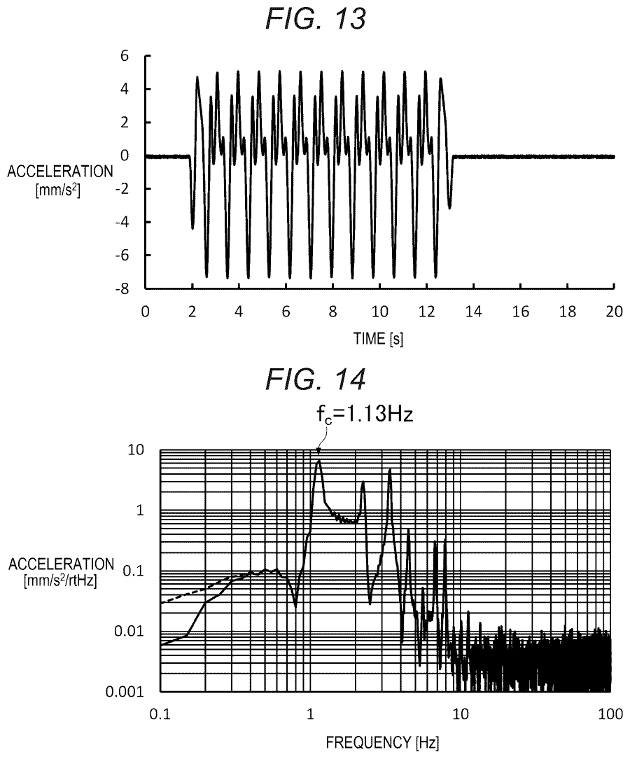

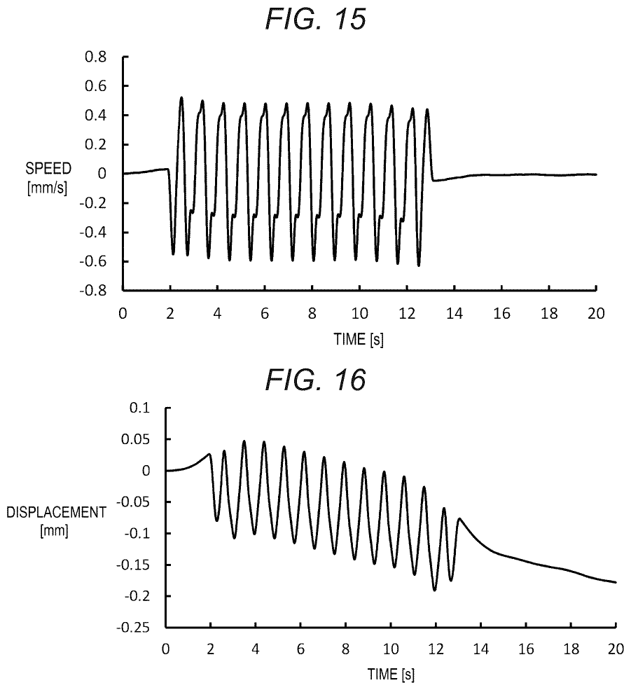

As an example, in the examples in FIGS. 6, 8, and 10, since the fundamental frequency f_{c} changes in a range of 0.77 Hz to 1.13 Hz, it is conceivable to perform filter processing using a high-pass filter in which a lower limit of the passband is fixed at a predetermined frequency lower than 0.77 Hz. FIG. 12 shows an example of a gain-frequency characteristic of such a high-pass filter. In the example in FIG. 12, the lower limit of the passband is between 0.4 Hz and 0.5 Hz. It is assumed that the filter processing is performed on the acceleration α(t) shown in FIG. 13 using the high-pass filter having the characteristic shown in FIG. 12. In FIG. 14, frequency spectrum obtained by performing fast Fourier transform on the acceleration α(t) shown in FIG. 13 is indicated by a solid line, and frequency spectrum obtained by performing fast Fourier transform on the acceleration after performing filter processing on the acceleration α(t) shown in FIG. 13 is indicated by a broken line. As shown in FIG. 14, the acceleration α(t) has a fundamental signal component having the fundamental frequency f_{c}=1.13 Hz, and an offset component or a noise component having a frequency lower than around 0.4 Hz is reduced by the filter processing. FIG. 15 shows the speed v(t) obtained by integrating the acceleration after the filter processing. FIG. 16 shows the displacement u(t) obtained by performing double integration on the acceleration after the filter processing. The speed v(t) shown in FIG. 15 slightly drifts. The displacement u(t) shown in FIG. 16 has a drift amount that is reduced as compared to the displacement u(t) shown in FIG. 5, that is, the displacement u(t) obtained by performing double integration on the acceleration α(t), but it cannot be said that the drift amount is sufficiently reduced. The drift of the speed v(t) shown in FIG. 15 or the displacement u(t) shown in FIG. 16 occurs due to the fact that the offset component and the noise component in a frequency range between a lower limit frequency of the passband and the fundamental frequency f_{c} in the acceleration α(t) are not reduced by the filter processing using the high-pass filter in which the lower limit frequency is fixed such that a lowest frequency in the assumed range of the fundamental frequency f_{c} is within the passband.

Similarly, there is a possibility that the drift of the speed v(t) or the displacement u(t) is not sufficiently reduced even when the filter processing is performed using the band-pass filter in which the lower limit frequency of the passband is fixed according to the lowest frequency in the assumed range of the fundamental frequency f_{c}. When the filter processing is performed using a low-pass filter or a band-pass filter in which an upper limit frequency of the passband is fixed according to a highest frequency in a range of the frequency that is n times the assumed fundamental frequency for there is a possibility that a noise component in a high-frequency range in the acceleration α(t) is not sufficiently reduced.

Therefore, in the embodiment, in order to sufficiently reduce the offset component and the noise component in the acceleration α(t), the measurement apparatus 1 calculates the fundamental frequency f_{c} of the acceleration α(t) and performs the filter processing on the acceleration α(t) using a filter having a passband variably set according to the fundamental frequency f_{c}. Three methods for calculating the fundamental frequency f_{c} are conceivable.

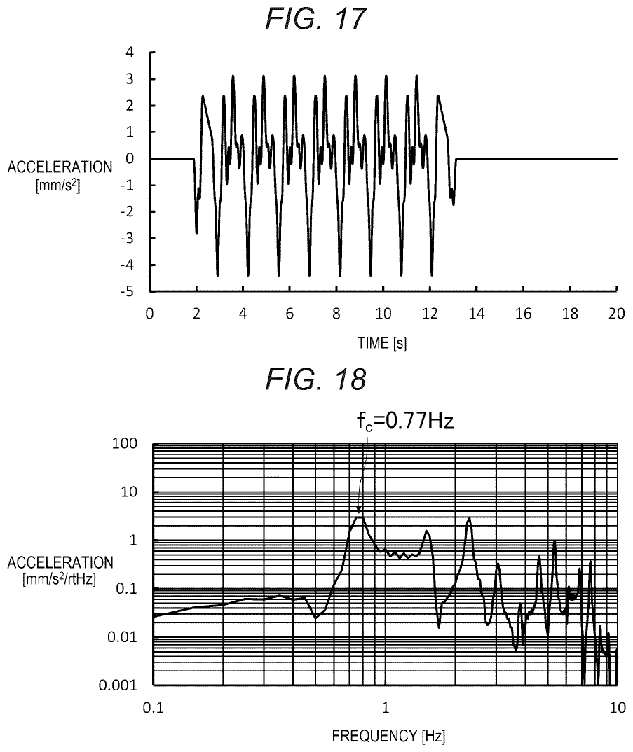

In a first calculation method for the fundamental frequency f_{c}, first, the measurement apparatus 1 calculates frequency spectrum by performing fast Fourier transform on the acceleration α(t). FIG. 17 shows an example of the acceleration α(t). FIG. 18 shows frequency spectrum obtained by performing fast Fourier transform on the acceleration α(t) shown in FIG. 17. Then, the measurement apparatus 1 calculates a lowest frequency among a plurality of frequencies corresponding to a plurality of peaks in the calculated frequency spectrum as the fundamental frequency f_{c}. In the example in FIG. 18, 0.77 Hz is calculated as the fundamental frequency f_{c}.

According to the first calculation method, the measurement apparatus 1 can accurately calculate the fundamental frequency f_{c} even though a calculation load is high since the fast Fourier transform is performed.

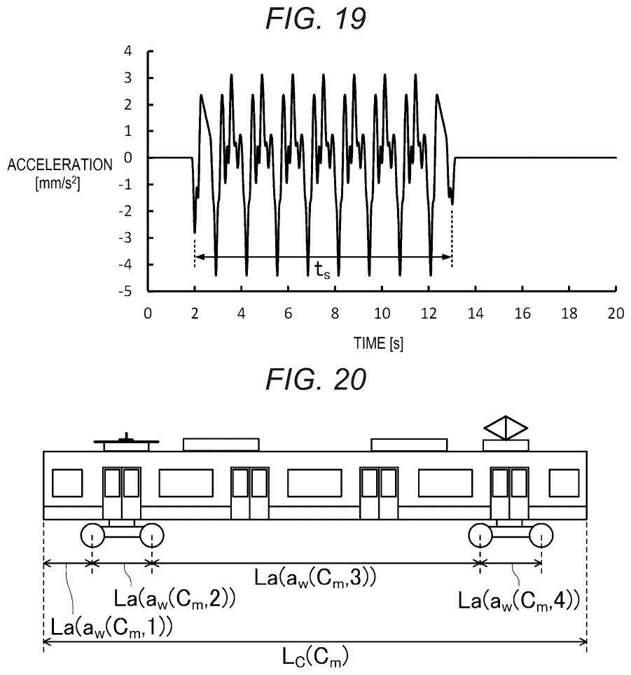

In a second calculation method for the fundamental frequency f_{c}, first, the measurement apparatus 1 calculates the passing time tₛ for the railway vehicle 6 to pass the bridge 5 based on the acceleration α(t). FIG. 19 shows a relationship between the acceleration α(t) and the passing time tₛ. As shown in FIG. 19, the measurement apparatus 1 calculates a time of a first negative peak of the acceleration α(t) as an entry time ti when the railway vehicle 6 enters the bridge 5, and calculates a time of a last negative peak of the acceleration α(t) as an exit time tₒ when the railway vehicle 6 exits the bridge 5. Then, the measurement apparatus 1 calculates a time from the entry time tᵢ to the exit time tₒ as the passing time tₛ as in Formula (1).

$${t}_{s} = {t}_{o} - {t}_{i} \qquad Math . 1$$

Next, the measurement apparatus 1 calculates the fundamental frequency f_{c} based on the calculated passing time tₛ and environmental information including a dimension of the railway vehicle 6 and a dimension of the bridge 5 which are created in advance. The environmental information includes the bridge length L_{B} that is the length of the bridge 5 as the dimension of the bridge 5. The environmental information also includes, as the dimension of the railway vehicle 6, for example, the number of cars C_{T} of the railway vehicle 6, a length L_{C}(Cₘ) of each car of the railway vehicle 6, the number of axles a_{T}(Cₘ) of each car, and an axle-to-axle distance La(a_{w}(Cₘ, n)) of each car. Here, Cₘ is a car number, and the length L_{C}(Cₘ) of each car is a distance between both ends of a Cₘ-th car from the front. The number of axles a_{T}(Cₘ) of each car is the number of axles of the Cₘ-th car from the front. Here, n is an axle number of each car and satisfies 1≤n≤a_{T}(Cₘ). The axle-to-axle distance La(a_{w}(Cₘ, n)) of each car is a distance between a front end of the Cₘ-th car from the front and a first axle from the front when n=1, and is a distance between an (n−1)-th axle and an n-th axle from the front when n≥2. FIG. 20 shows an example of the length L_{C}(Cₘ) and the axle-to-axle distance La(a_{w}(Cₘ, n)) of the Cₘ-th car of the railway vehicle 6. The dimension of the railway vehicle 6 can be measured using a known method. A database of the dimension of the railway vehicle 6 passing the bridge 5 may be created in advance, and a dimension of a corresponding car may be referred to based on a passing time.

The measurement apparatus 1 calculates the fundamental frequency f_{c} using Formula (2) based on the calculated passing time tₛ and the number of cars C_{T}, the length of each car L_{C}=L_{C}(Cₘ), and the bridge length L_{B} contained in the environmental information. In Formula (2), a sum of a distance from a front end of the railway vehicle 6 to a first axle of a first car and a distance from a last axle of a last car to a rear end of the railway vehicle 6 is 4.1 m, and the measurement apparatus 1 may calculate the sum based on the environmental information.

$${f}_{C} = \frac{{C}_{T}}{{t}_{S}} \times \frac{{L}_{C} {C}_{T} - 4.1 + {L}_{B}}{{L}_{C} {C}_{T} - 4.1} \qquad Math . 2$$

According to the second calculation method, since the measurement apparatus 1 does not need to perform the fast Fourier transform, the fundamental frequency f_{c} can be calculated with a low load.

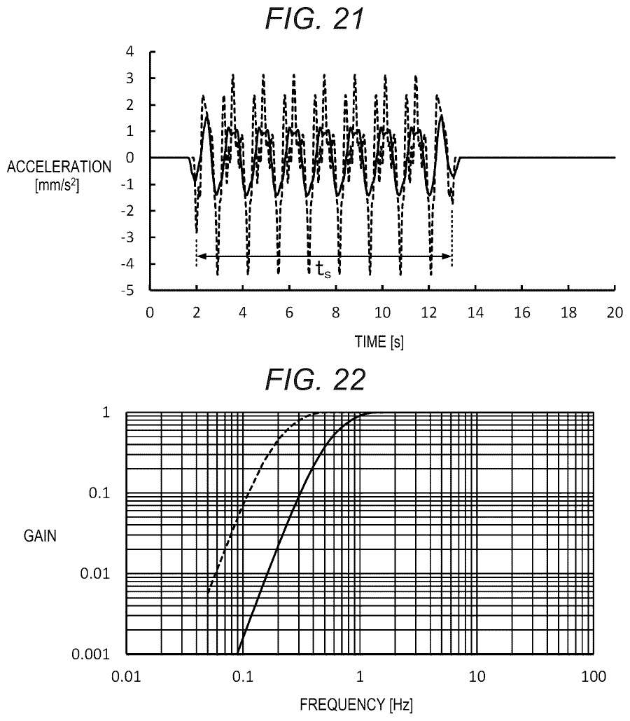

In a third calculation method for the fundamental frequency f_{c}, first, the measurement apparatus 1 calculates the number of cycles Tₙ of the acceleration α(t) and the passing time tₛ for the railway vehicle 6 to pass the bridge 5 based on the acceleration α(t), as in the second calculation method. A method for calculating the passing time tₛ is the same as that in the second method for calculating the fundamental frequency f_{c}. For example, the measurement apparatus 1 calculates an acceleration α_{LPF}(t) obtained by performing low-pass filter processing on the acceleration α(t), and counts the number of positive peaks Pₚ or the number of negative peaks Pₙ of the acceleration α_{LPF}(t). In FIG. 21, the acceleration α_{LPF}(t) obtained by performing the low-pass filter processing on the acceleration α(t) shown in FIG. 19 is indicated by a solid line. In FIG. 21, the acceleration α(t) is also indicated by a broken line. In the example in FIG. 21, the number of positive peaks Pₚ of the acceleration α_{LPF}(t) is 9, and the number of negative peaks Pₙ of the acceleration α_{LPF}(t) is 10. The measurement apparatus 1 calculates the number of cycles Tₙ using Formula (3) based on the number of positive peaks Pₚ or the number of negative peaks Pₙ.

$${T}_{n} = {P}_{p} - 1 = {P}_{n} - 2 \qquad Math . 3$$

The measurement apparatus 1 calculates the fundamental frequency f_{c} based on the calculated number of cycles Tₙ and the passing time tₛ. Specifically, the measurement apparatus 1 calculates the fundamental frequency f_{c} by dividing the number of cycles Tₙ by the passing time tₛ as in Formula (4).

$${f}_{C} = \frac{{T}_{n}}{{t}_{S}} = \frac{{P}_{n} - 1}{{t}_{S}} = \frac{{P}_{n} - 2}{{t}_{S}} \qquad Math . 4$$

According to the third calculation method, since the measurement apparatus 1 does not need to perform the fast Fourier transform, the fundamental frequency f_{c} can be calculated with a low load.

Next, the measurement apparatus 1 generates the filter having the passband variably set based on the fundamental frequency f_{c} calculated using any of the first to third calculation methods. For example, the filter may be a high-pass filter or a band-pass filter. The band-pass filter may include a high-pass filter and a low-pass filter. When the filter is the high-pass filter, the measurement apparatus 1 generates a filter having a cutoff frequency higher than half of the fundamental frequency f_{c} and lower than the fundamental frequency f_{c}. That is, the measurement apparatus 1 generates a filter that allows at least a signal component having a frequency equal to or higher than the fundamental frequency f_{c} to pass therethrough and attenuates at least a signal component having a frequency equal to or lower than half of the fundamental frequency f_{c}. For example, as shown in FIG. 14, since the fundamental frequency f_{c} of the acceleration α(t) in FIG. 13 is 1.13 Hz, the measurement apparatus 1 generates, for example, a high-pass filter having a cutoff frequency higher than half of 1.17 Hz and lower than 1.17 Hz. In FIG. 22, an example of a gain-frequency characteristic of the high-pass filter is indicated by a solid line. In FIG. 22, the gain-frequency characteristic of the high-pass filter shown in FIG. 12 is indicated by a broken line.

When the filter is the band-pass filter, the measurement apparatus 1 generates a filter having a first cutoff frequency higher than half of the fundamental frequency f_{c} and lower than the fundamental frequency f_{c}, and a second cutoff frequency higher than n times the fundamental frequency f_{c} and lower than n+1 times the fundamental frequency f_{c}. Here, n is the predetermined integer. That is, the measurement apparatus 1 generates a filter that allows at least a signal component having a frequency equal to or higher than the fundamental frequency f_{c} and equal to or lower than n times the fundamental frequency f_{c} to pass therethrough and attenuates at least a signal component having a frequency equal to or lower than half of the fundamental frequency f_{c} and a signal component having a frequency equal to or higher than n+1 times the fundamental frequency f_{c}.

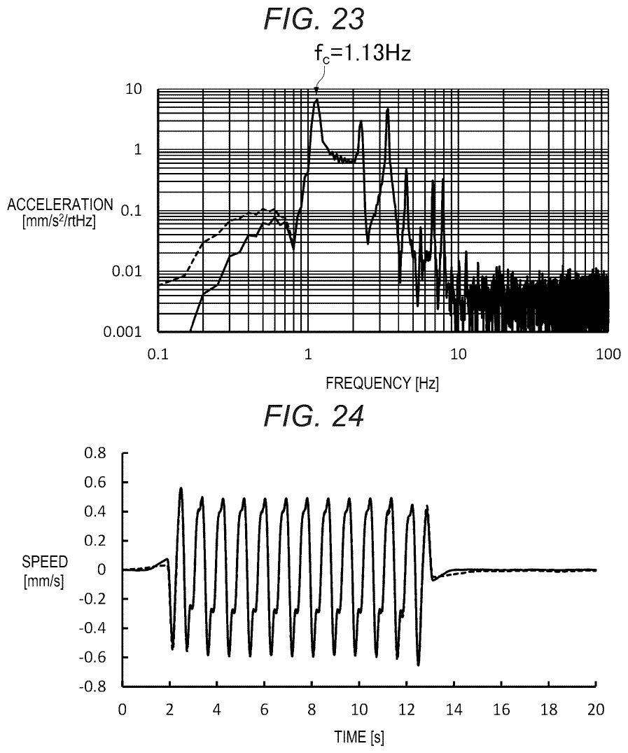

Next, the measurement apparatus 1 performs filter processing on the acceleration α(t) using the generated filter. In FIG. 23, a solid line indicates frequency spectrum obtained by performing fast Fourier transform on the acceleration after performing the filter processing on the acceleration α(t) shown in FIG. 13 using the high-pass filter having the characteristic indicated by the solid line in FIG. 22. In FIG. 23, a broken line indicates frequency spectrum obtained by performing fast Fourier transform on the acceleration after performing the filter processing on the acceleration α(t) shown in FIG. 13 using the high-pass filter having the characteristic indicated by the broken line in FIG. 22. As shown in FIG. 23, when the acceleration α(t) is subjected to the filter processing using the high-pass filter having the characteristic indicated by the solid line in FIG. 22, the offset component and the noise component in the low-frequency range are more greatly attenuated than when the filter processing is performed using the high-pass filter having the characteristic indicated by the broken line in FIG. 22.

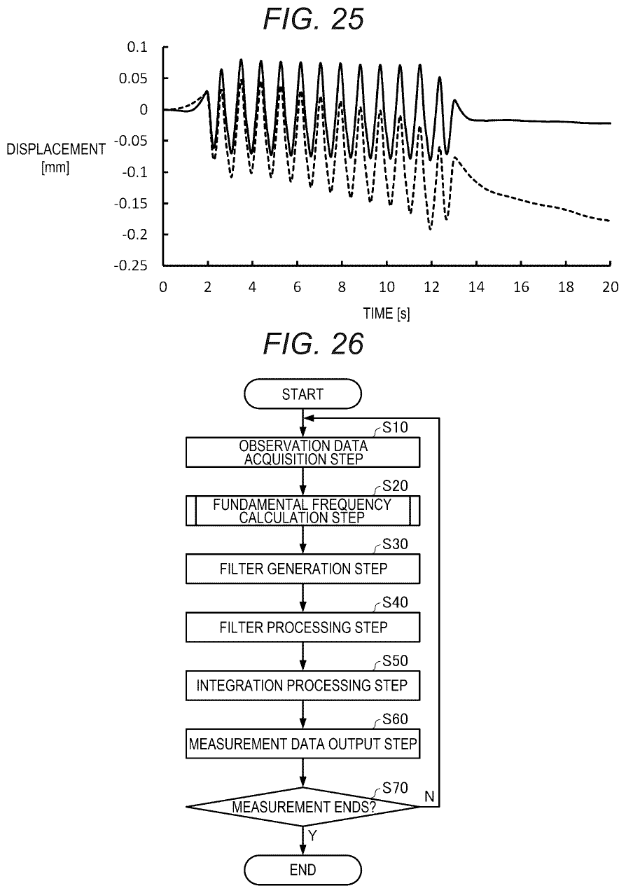

The measurement apparatus 1 performs integration processing on the acceleration obtained by the filter processing to calculate the speed v(t) and the displacement u(t). In FIG. 24, the speed v(t) obtained by integrating the acceleration after performing the filter processing on the acceleration α(t) shown in FIG. 13 using the high-pass filter having the characteristic indicated by the solid line in FIG. 22 is indicated by a solid line. In FIG. 24, the speed v(t) obtained by integrating the acceleration after performing the filter processing on the acceleration α(t) shown in FIG. 13 using the high-pass filter having the characteristic shown by the broken line in FIG. 22 is indicated by a broken line. As shown in FIG. 24, drift is reduced more in the speed v(t) indicated by the solid line than in the speed v(t) indicated by the broken line. In FIG. 25, the displacement u(t) obtained by performing double integration on the acceleration after performing the filter processing on the acceleration α(t) shown in FIG. 13 using the high-pass filter having the characteristic indicated by the solid line in FIG. 22 is indicated by a solid line. In FIG. 25, the displacement u(t) obtained by performing double integration on the acceleration after performing the filter processing on the acceleration α(t) shown in FIG. 13 using the high-pass filter having the characteristic indicated by the broken line in FIG. 22 is indicated by a broken line. As shown in FIG. 25, drift is more greatly reduced in the displacement u(t) indicated by the solid line than in the displacement u(t) indicated by the broken line.

In this way, in the embodiment, the measurement apparatus 1 performs the filter processing on the acceleration α(t) using the filter having the passband appropriately set according to the fundamental frequency f_{c} of the acceleration α(t) contained in the observation data, integrates the acceleration after the filter processing, and thus can significantly reduce the drift of the speed v(t) or the displacement u(t).

### 1-3. Procedure of Measurement Method

FIG. 26 is a flowchart showing an example of a procedure of a measurement method according to a first embodiment. In the embodiment, the measurement apparatus 1 performs the procedure shown in FIG. 26.

As shown in FIG. 26, first, in an observation data acquisition step S10, the measurement apparatus 1 acquires the observation data output from the sensor 2 that is the observation apparatus. The observation data includes a response to actions of a plurality of parts of the railway vehicle 6 traveling on the bridge 5 on the observation point R. In the embodiment, the sensor 2 is an acceleration sensor provided at the bridge 5, and the observation data includes an acceleration as the response.

Next, in a fundamental frequency calculation step S20, the measurement apparatus 1 calculates the fundamental frequency f_{c} of the deflection repeatedly generated at the bridge 5 due to the traveling of the railway vehicle 6 based on first measurement data based on the acceleration data that is the observation data acquired in step S10. The first measurement data may be the acceleration data, or may be data obtained by performing predetermined processing such as low-pass filter processing on the acceleration data. An example of a procedure of the fundamental frequency calculation step S20 will be described later.

Next, in a filter generation step S30, the measurement apparatus 1 generates the filter having the passband variably set according to the fundamental frequency f_{c} based on the fundamental frequency f_{c} calculated in step S20. For example, the filter may be the high-pass filter or the band-pass filter. The band-pass filter may include the high-pass filter and the low-pass filter. When the filter is the high-pass filter, the measurement apparatus 1 generates the filter having the cutoff frequency higher than half of the fundamental frequency f_{c} and lower than the fundamental frequency f_{c}. When the filter is the band-pass filter, the measurement apparatus 1 generates the filter having the first cutoff frequency higher than half of the fundamental frequency f_{c} and lower than the fundamental frequency f_{c}, and the second cutoff frequency higher than n times the fundamental frequency f_{c} and lower than n+1 times the fundamental frequency f_{c}. Here, n is the predetermined integer.

Next, in a filter processing step S40, the measurement apparatus 1 performs the filter processing on the first measurement data using the filter generated in step S30 to generate second measurement data. That is, the measurement apparatus 1 performs the filter processing on the first measurement data using the high-pass filter or the band-pass filter generated in step S30.

Next, in an integration processing step S50, the measurement apparatus 1 performs integration processing on the second measurement data generated in step S40 to generate third measurement data. For example, the second measurement data may be acceleration data, and the measurement apparatus 1 may integrate the second measurement data to generate speed data as the third measurement data, or may perform double integration on the second measurement data to generate displacement data as the third measurement data.

Next, in a measurement data output step S60, the measurement apparatus 1 outputs the measurement data including the third measurement data calculated in step S50 to the monitoring apparatus 3. Specifically, the measurement apparatus 1 transmits the measurement data to the monitoring apparatus 3 via the communication network 4. The measurement data may further include the first measurement data, the second measurement data, and the like.

The measurement apparatus 1 repeats the processing of steps S10 to S60 until measurement is ended in step S70.

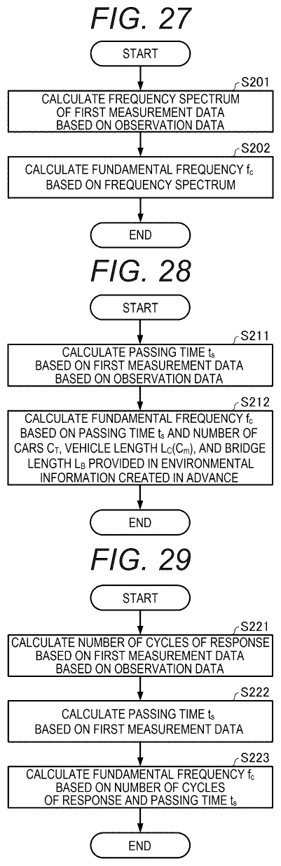

FIG. 27 is a flowchart showing the example of the procedure of the fundamental frequency calculation step S20 in FIG. 26. The flowchart in FIG. 27 corresponds to a procedure of the first calculation method for the fundamental frequency f_{c} described above.

As shown in FIG. 27, first, in step S201, the measurement apparatus 1 calculates frequency spectrum of the first measurement data based on the observation data. For example, the measurement apparatus 1 may calculate the frequency spectrum by performing fast Fourier transform on the first measurement data.

In step S202, the measurement apparatus 1 calculates the fundamental frequency f_{c} based on the frequency spectrum calculated in step S201. For example, the measurement apparatus 1 may calculate a lowest frequency among a plurality of frequencies corresponding to a plurality of peaks in the frequency spectrum as the fundamental frequency f_{c}.

FIG. 28 is a flowchart showing another example of the procedure of the fundamental frequency calculation step S20 in FIG. 26. The flowchart in FIG. 28 corresponds to a procedure of the second calculation method for the fundamental frequency f_{c} described above.

As shown in FIG. 28, first, in step S211, the measurement apparatus 1 calculates the passing time tₛ based on the first measurement data based on the observation data. For example, for the first measurement data, the measurement apparatus 1 may calculate the time of the first negative peak when the railway vehicle 6 travels on the bridge 5 as the entry time tᵢ, calculate the time of the last negative peak as the exit time tₒ, and calculate the time from the entry time tᵢ to the exit time tₒ as the passing time tₛ as in Formula (1) described above.

In step S212, the measurement apparatus 1 calculates the fundamental frequency f_{c} based on the passing time tₛ calculated in step S211 and the number of cars C_{T} of the railway vehicle 6, the vehicle length L_{C}(Cₘ) that is the length of each car of the railway vehicle 6, and the bridge length L_{B} that is the length of the bridge 5 contained in the environmental information created in advance. For example, the measurement apparatus 1 may calculate the fundamental frequency f_{c} using Formula (2) described above.

FIG. 29 is a flowchart showing another example of the procedure of the fundamental frequency calculation step S20 in FIG. 26. The flowchart in FIG. 29 corresponds to a procedure of the third calculation method for the fundamental frequency f_{c} described above.

As shown in FIG. 29, first, in step S221, the measurement apparatus 1 calculates the number of cycles Tₙ of the response to the action of the railway vehicle 6 traveling on the bridge 5 on the observation point R based on the first measurement data based on the observation data. For example, for the first measurement data, the measurement apparatus 1 may count the number of positive peaks Pₚ or the number of negative peaks Pₙ when the railway vehicle 6 travels on the bridge 5 and calculate the number of cycles Tₙ using Formula (3) described above.

Next, in step S222, the measurement apparatus 1 calculates the passing time tₛ based on the first measurement data. For example, for the first measurement data, the measurement apparatus 1 may calculate the time of the first negative peak when the railway vehicle 6 travels on the bridge 5 as the entry time tᵢ, calculate the time of the last negative peak as the exit time tₒ, and calculate the time from the entry time tᵢ to the exit time tₒ as the passing time tₛ as in Formula (1) described above.

In step S223, the measurement apparatus 1 calculates the fundamental frequency f_{c} based on the number of cycles Tₙ of the response calculated in step S221 and the passing time tₛ calculated in step S222. Specifically, the measurement apparatus 1 calculates the fundamental frequency f_{c} by dividing the number of cycles Tₙ by the passing time tₛ as in Formula (4) described above.

### 1-4. Configurations of Sensor, Measurement Apparatus, and Monitoring Apparatus

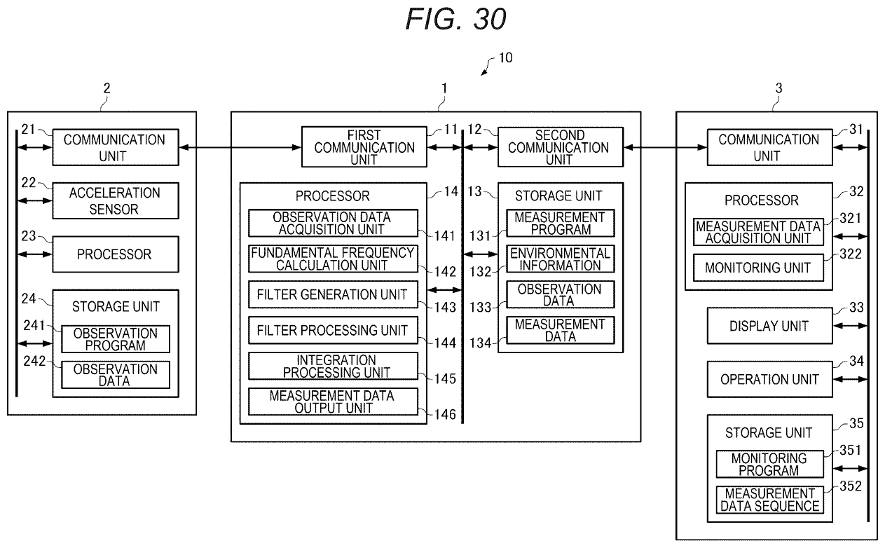

FIG. 30 shows a configuration example of the sensor 2, the measurement apparatus 1, and the monitoring apparatus 3. As shown in FIG. 30, the sensor 2 includes a communication unit 21, an acceleration sensor 22, a processor 23, and a storage unit 24.

The storage unit 24 is a memory that stores various programs, data, and the like for the processor 23 to perform calculation processing and control processing. The storage unit 24 also stores a program, data, and the like for the processor 23 to implement a predetermined application function.

The acceleration sensor 22 detects an acceleration generated in each axial direction of the three axes.

The processor 23 controls the acceleration sensor 22 by executing an observation program 241 stored in the storage unit 24, generates observation data 242 based on the acceleration detected by the acceleration sensor 22, and stores the generated observation data 242 in the storage unit 24. In the embodiment, the observation data 242 is the acceleration data.

The communication unit 21 transmits the observation data 242 stored in the storage unit 24 to the measurement apparatus 1 under control of the processor 23.

As shown in FIG. 30, the measurement apparatus 1 includes a first communication unit 11, a second communication unit 12, a storage unit 13, and a processor 14.

The first communication unit 11 receives the observation data 242 from the sensor 2 and outputs the received observation data 242 to the processor 14.

The storage unit 13 is a memory that stores a program, data, and the like for the processor 14 to perform calculation processing and control processing. The storage unit 13 also stores various programs, data, and the like for the processor 14 to implement a predetermined application function. The processor 14 may receive various programs, data, and the like via the communication network 4 and store the programs, the data, and the like in the storage unit 13.

The processor 14 generates measurement data 134 based on the observation data 242 received by the first communication unit 11, and stores the generated measurement data 134 in the storage unit 13.

In the embodiment, the processor 14 functions as an observation data acquisition unit 141, a fundamental frequency calculation unit 142, a filter generation unit 143, a filter processing unit 144, an integration processing unit 145, and a measurement data output unit 146 by executing a measurement program 131 stored in the storage unit 13. That is, the processor 14 includes the observation data acquisition unit 141, the fundamental frequency calculation unit 142, the filter generation unit 143, the filter processing unit 144, the integration processing unit 145, and the measurement data output unit 146.

The observation data acquisition unit 141 acquires the observation data 242 received by the first communication unit 11 and stores the observation data 242 in the storage unit 13 as observation data 133. That is, the observation data acquisition unit 141 performs the processing of the observation data acquisition step S10 in FIG. 26. In the embodiment, the observation data 133 is the acceleration data.

The fundamental frequency calculation unit 142 calculates the fundamental frequency f_{c} of the deflection repeatedly generated at the bridge 5 due to the traveling of the railway vehicle 6 based on the first measurement data based on the observation data 133 acquired by the observation data acquisition unit 141 and stored in the storage unit 13. The first measurement data may be the acceleration data, which is the observation data 133, or may be data obtained by performing predetermined processing such as low-pass filter processing on the acceleration data. For example, the fundamental frequency calculation unit 142 may calculate the frequency spectrum of the first measurement data and calculate the fundamental frequency f_{c} based on the calculated frequency spectrum. Alternatively, the fundamental frequency calculation unit 142 may calculate the passing time tₛ based on the first measurement data, calculate the number of cycles Tₙ of the response and the passing time tₛ based on the calculated passing time tₛ and the number of cars C_{T} of the railway vehicle 6, the car length L_{C}(Cₘ) that is the length of each car of the railway vehicle 6, and the bridge length L_{B} that is the length of the bridge 5 contained in environmental information 132 created in advance and stored in the storage unit 13, and calculate the fundamental frequency f_{c} based on the number of cycles Tₙ of the response and the passing time tₛ thus calculated. That is, the fundamental frequency calculation unit 142 performs the processing of the fundamental frequency calculation step S20 in FIG. 26, specifically, the processing of steps S201 and S202 in FIG. 27, the processing of steps S211 and S212 in FIG. 28, or the processing of steps S221, S222, and S223 in FIG. 29.

The filter generation unit 143 generates the filter having the passband variably set based on the fundamental frequency f_{c} calculated by the fundamental frequency calculation unit 142. For example, the filter may be the high-pass filter or the band-pass filter. The band-pass filter may include the high-pass filter and the low-pass filter. When the filter is the high-pass filter, the filter generation unit 143 generates the filter having the cutoff frequency higher than half of the fundamental frequency f_{c} and lower than the fundamental frequency f_{c}. When the filter is the band-pass filter, the filter generation unit 143 generates the filter having the first cutoff frequency higher than half of the fundamental frequency f_{c} and lower than the fundamental frequency for and the second cutoff frequency higher than n times the fundamental frequency f_{c} and lower than n+1 times the fundamental frequency f_{c}. Here, n is the predetermined integer. That is, the filter generation unit 143 performs the processing of the filter generation step S30 in FIG. 26.

The filter processing unit 144 performs the filter processing on the first measurement data using the filter generated by the filter generation unit 143 to generate the second measurement data. The filter processing unit 144 performs the filter processing on the first measurement data using the high-pass filter or the band-pass filter generated by the filter generation unit 143. That is, the filter processing unit 144 performs the processing of the filter processing step S40 in FIG. 26.

The integration processing unit 145 performs integration processing on the second measurement data generated by the filter processing unit 144 to generate the third measurement data. For example, the second measurement data may be the acceleration data, and the integration processing unit 145 may integrate the second measurement data to generate speed data as the third measurement data, or may perform double integration on the second measurement data to generate displacement data as the third measurement data. That is, the integration processing unit 145 performs the processing of the integration processing step S50 in FIG. 26.

The third measurement data calculated by the integration processing unit 145 is stored in the storage unit 13 as at least a part of the measurement data 134. The measurement data 134 may further include the first measurement data, the second measurement data, and the like.

The measurement data output unit 146 reads the measurement data 134 stored in the storage unit 13 and outputs the measurement data 134 to the monitoring apparatus 3. Specifically, under control of the measurement data output unit 146, the second communication unit 12 transmits the measurement data 134 stored in the storage unit 13 to the monitoring apparatus 3 via the communication network 4. That is, the measurement data output unit 146 performs the processing of the measurement data output step S60 in FIG. 26.

In this way, the measurement program 131 is a program that causes the measurement apparatus 1, which is a computer, to execute each procedure in the flowchart shown in FIG. 26.

As shown in FIG. 30, the monitoring apparatus 3 includes a communication unit 31, a processor 32, a display unit 33, an operation unit 34, and a storage unit 35.

The communication unit 31 receives the measurement data 134 from the measurement apparatus 1 and outputs the received measurement data 134 to the processor 32.

The display unit 33 displays various types of information under control of the processor 32. The display unit 33 may be, for example, a liquid crystal display or an organic EL display. EL is an abbreviation for electro luminescence.

The operation unit 34 outputs operation data corresponding to an operation performed by a user to the processor 32. The operation unit 34 may be an input device such as a mouse, a keyboard, or a microphone.

The storage unit 35 is a memory that stores various programs, data, and the like for the processor 32 to perform calculation processing and control processing. The storage unit 35 also stores a program, data, and the like for the processor 32 to implement a predetermined application function.

The processor 32 acquires the measurement data 134 received by the communication unit 31, generates evaluation information by evaluating the passing speed of the railway vehicle 6 or a change over time in the displacement of the bridge 5 based on the acquired measurement data 134, and displays the generated evaluation information on the display unit 33.

In the embodiment, the processor 32 functions as a measurement data acquisition unit 321 and a monitoring unit 322 by executing a monitoring program 351 stored in the storage unit 35. That is, the processor 32 includes the measurement data acquisition unit 321 and the monitoring unit 322.

The measurement data acquisition unit 321 acquires the measurement data 134 received by the communication unit 31 and adds the acquired measurement data 134 to a measurement data sequence 352 stored in the storage unit 35.

The monitoring unit 322 evaluates the passing speed of the railway vehicle 6 based on the measurement data sequence 352 stored in the storage unit 35, and statistically evaluates the change over time in the displacement of the bridge 5. Then, the monitoring unit 322 generates the evaluation information indicating an evaluation result and displays the generated evaluation information on the display unit 33. Based on the evaluation information displayed on the display unit 33, the user can monitor the passing speed of the railway vehicle 6 and a state of the bridge 5.

The monitoring unit 322 may perform processing such as monitoring of the railway vehicle 6 and abnormality determination of the bridge 5 based on the measurement data sequence 352 stored in the storage unit 35.

The processor 32 transmits, based on the operation data output from the operation unit 34, information for adjusting an operation status of the measurement apparatus 1 or the sensor 2 to the measurement apparatus 1 via the communication unit 31. The operation status of the measurement apparatus 1 is adjusted based on the information received via the second communication unit 12. The measurement apparatus 1 transmits the information for adjusting the operation status of the sensor 2 received via the second communication unit 12 to the sensor 2 via the first communication unit 11. The operation status of the sensor 2 is adjusted based on the information received via the communication unit 21.

In the processors 14, 23, and 32, for example, functions of each part may be implemented using individual pieces of hardware, or the functions of each part may be implemented using integrated hardware. For example, the processors 14, 23, and 32 include hardware, and the hardware may include at least one of a circuit for processing a digital signal and a circuit for processing an analog signal. The processors 14, 23, and 32 may be a CPU, a GPU, a DSP, or the like. CPU is an abbreviation for a central processing unit, GPU is an abbreviation for a graphics processing unit, and DSP is an abbreviation for a digital signal processor. The processors 14, 23, and 32 may each be implemented as a custom IC such as an ASIC to implement the function of each unit, or the function of each unit may be implemented by a CPU and an ASIC. ASIC is an abbreviation for an application-specific integrated circuit, and IC is an abbreviation for an integrated circuit.

The storage units 13, 24, and 35 each include a recording medium, for example, various IC memories such as a ROM, a flash ROM, and a RAM, a hard disk, or a memory card. ROM is an abbreviation for a read-only memory, RAM is an abbreviation for a random access memory, and is an abbreviation for an integrated circuit. The storage units 13, 24, and 35 each include a non-volatile information storage device that is a computer-readable device or medium, and various programs, data, and the like may be stored in the information storage device. The information storage device may be an optical disk such as an optical disk DVD or CD, a hard disk drive, or various types of memories such as a card-type memory or a ROM.

Only one sensor 2 is shown in FIG. 30, and alternatively, a plurality of sensors 2 may each generate the observation data 242 and transmit the observation data 242 to the measurement apparatus 1. In this case, the measurement apparatus 1 receives a plurality of pieces of observation data 242 transmitted from the plurality of sensors 2, generates a plurality of pieces of measurement data 134, and transmits the plurality of pieces of measurement data 134 to the monitoring apparatus 3. The monitoring apparatus 3 receives the plurality of pieces of measurement data 134 transmitted from the measurement apparatus 1 and monitors the state of the bridge 5 based on the received plurality of pieces of measurement data 134.

### 1-5. Functions and Effects

As described above, in the measurement method in the first embodiment, the measurement apparatus 1 generates the second measurement data by performing the filter processing e first measurement data based on the observation data using the filter having the passband variably set according to the fundamental frequency f_{c} of the deflection repeatedly generated at the bridge 5 due to the traveling of the railway vehicle 6. Therefore, in the measurement method in the first embodiment, even when the fundamental frequency f_{c} changes due to the passing time tₛ, the number of cars C_{T}, the bridge length L_{B}, and the like, the measurement apparatus 1 can generate the second measurement data in which the offset error and the noise component are effectively attenuated using an appropriate high-pass filter or band-pass filter corresponding thereto. Therefore, according to this measurement method, it is possible to reduce drift caused by the measurement apparatus 1 performing the integration processing on the second measurement data.

For example, the measurement apparatus 1 can generate the second measurement data in which at least a noise component having a frequency equal to or lower than half of the fundamental frequency f_{c} is attenuated by performing the filter processing on the first measurement data using the high-pass filter having the cutoff frequency higher than half of the fundamental frequency f_{c} and lower than the fundamental frequency f_{c}. Therefore, the measurement apparatus 1 can reduce the drift and the low-frequency noise component caused by performing the integration processing on the second measurement data.

For example, by performing the filter processing on the first measurement data using the band-pass filter having the first cutoff frequency higher than half of the fundamental frequency f_{c} and lower than the fundamental frequency f_{c} and the second cutoff frequency higher than n times the fundamental frequency f_{c} and lower than n+1 times the fundamental frequency f_{c}, the measurement apparatus 1 can at least generate the second measurement data in which a noise component having a frequency equal to or lower than half of the fundamental frequency f_{c} is attenuated and a noise component having a frequency equal to or higher than n+1 times the fundamental frequency f_{c} is attenuated. Therefore, the measurement apparatus 1 can reduce the drift, the low-frequency noise component, and the high-frequency noise component generated due to the integration processing on the second measurement data in which a signal component having the fundamental frequency f_{c} and second to n-th harmonic signal components thereof are measurement targets.

In particular, the measurement apparatus 1 can reduce the drift and the low-frequency noise component generated in the third measurement data, which is the speed data or the displacement data, by performing the integration processing on the second measurement data that is the acceleration data.

### 2. Second Embodiment

Hereinafter, in a second embodiment, the same components as those in the first embodiment will be denoted by the same reference signs, repetitive description as that in the first embodiment will be omitted or simplified, and contents different from those in the first embodiment will be mainly described.

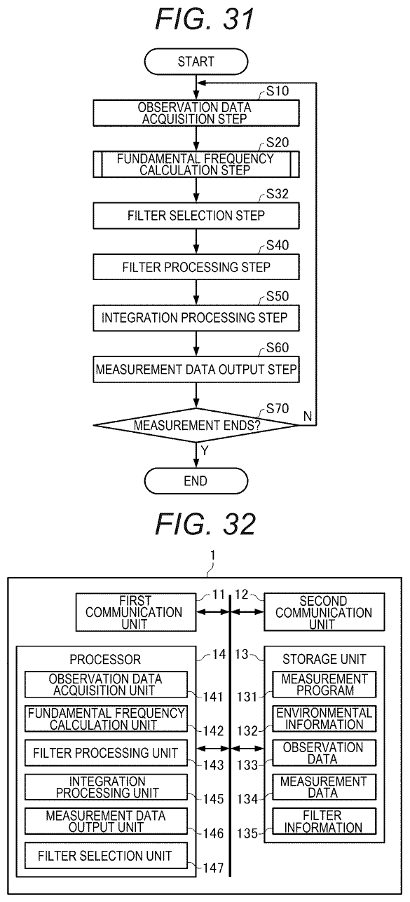

FIG. 31 is a flowchart showing an example of a procedure of a measurement method according to the second embodiment. In FIG. 31, the same steps as those in FIG. 26 are denoted by the same reference signs. In the embodiment, the measurement apparatus 1 performs the procedure shown in FIG. 31.

As shown in FIG. 31, first, the measurement apparatus 1 performs the observation data acquisition step S10 and further performs the fundamental frequency calculation step S20. Since the processing of the observation data acquisition step S10 and the fundamental frequency calculation step S20 are the same as those in the first embodiment, description thereof will be omitted.

Next, the measurement apparatus 1 performs a filter selection step S32 instead of the filter generation step S30 in FIG. 26. In the filter selection step S32, the measurement apparatus 1 selects, based on the fundamental frequency f_{c} calculated in step S20 and filter information created in advance that is information on a plurality of filters having different passbands, a filter to be used in the filter processing on the first measurement data from the plurality of filters.

For example, the filter information is information indicating a correspondence relationship between each of a plurality of fundamental frequencies and each coefficient value of the plurality of filters having different passbands. The plurality of filters may be FIR filters having the same order. FIR is an abbreviation for a finite impulse response. Each of the plurality of filters may be a high-pass filter having a cutoff frequency higher than half of the fundamental frequency and lower than the fundamental frequency. Each of the plurality of filters may also be a band-pass filter having the first cutoff frequency higher than half of the fundamental frequency and lower than the fundamental frequency, and the second cutoff frequency higher than n times the fundamental frequency and lower than n+1 times the fundamental frequency. Here, n is the predetermined integer. The band-pass filter may include a high-pass filter and a low-pass filter. The measurement apparatus 1 may select a filter corresponding to the fundamental frequency closest to the calculated fundamental frequency f_{c} with reference to the filter information. In this way, the measurement apparatus 1 selects the filter having the passband variably set according to the fundamental frequency f_{c} based on the fundamental frequency f_{c}.

Next, in the filter processing step S40, the measurement apparatus 1 performs the filter processing on the first measurement data using the filter selected in step S30 to generate the second measurement data. That is, the measurement apparatus 1 performs the filter processing on the first measurement data using the high-pass filter or the band-pass filter selected in step S30.

Next, the measurement apparatus 1 performs the integration processing step S50 and further performs the measurement data output step S60. Since the processing of the integration processing step S50 and the measurement data output step S60 is the same as that in the first embodiment, description thereof will be omitted.

The measurement apparatus 1 repeats the processing of steps S10 to S60 until measurement is ended in step S70.

Since configurations and functions of the sensor 2 and the monitoring apparatus 3 in the second embodiment are the same as those in the first embodiment, illustration thereof is omitted. FIG. 32 shows a configuration example of the measurement apparatus 1 in the second embodiment.

As shown in FIG. 32, the measurement apparatus 1 in the second embodiment includes the first communication unit 11, the second communication unit 12, the storage unit 13, and the processor 14 as in the first embodiment. Since functions of the first communication unit 11, the second communication unit 12, and the storage unit 13 are the same as those in the first embodiment, description thereof will be omitted.

In the second embodiment, the processor 14 functions as the observation data acquisition unit 141, the fundamental frequency calculation unit 142, the filter processing unit 144, the integration processing unit 145, the measurement data output unit 146, and a filter selection unit 147 by executing the measurement program 131 stored in the storage unit 13. That is, the processor 14 includes the observation data acquisition unit 141, the fundamental frequency calculation unit 142, the filter processing unit 144, the integration processing unit 145, the measurement data output unit 146, and the filter selection unit 147. Since functions of the observation data acquisition unit 141, the fundamental frequency calculation unit 142, the integration processing unit 145, and the measurement data output unit 146 are the same as those in the first embodiment, description thereof will be omitted. The observation data acquisition unit 141 performs the processing of the observation data acquisition step S10 in FIG. 31. The fundamental frequency calculation unit 142 performs the processing of the fundamental frequency calculation step S20 in FIG. 31, specifically, the processing of steps S201 and S202 in FIG. 27, the processing of steps S211 and S212 in FIG. 28, or the processing of steps S221, S222, and S223 in FIG. 29. The integration processing unit 145 performs the processing of the integration processing step S50 in FIG. 31. The measurement data output unit 146 performs the processing of the measurement data output step S60 in FIG. 31.

The filter selection unit 147 selects, based on the fundamental frequency f_{c} calculated by the fundamental frequency calculation unit 142 and filter information 135 created in advance and stored in the storage unit 13, which is information on the plurality of filters having different passbands, the filter to be used in the filter processing on the first measurement data based on the observation data from the plurality of filters.

For example, the filter information 135 is information indicating the correspondence relationship between each of the plurality of fundamental frequencies and each coefficient value of the plurality of filters having different passbands. The plurality of filters may be FIR filters having the same order. Each of the plurality of filters may be the high-pass filter having the cutoff frequency higher than half of the fundamental frequency and lower than the fundamental frequency. Each of the plurality of filters may also be the band-pass filter having the first cutoff frequency higher than half of the fundamental frequency and lower than the fundamental frequency, and the second cutoff frequency higher than n times the fundamental frequency and lower than n+1 times the fundamental frequency. Here, n is the predetermined integer. The band-pass filter may include the high-pass filter and the low-pass filter. The filter selection unit 147 may select the filter corresponding to the fundamental frequency closest to the fundamental frequency f_{c} calculated by the fundamental frequency calculation unit 142 with reference to the filter information 135. In this way, the filter selection unit 147 selects the filter having the passband variably set according to the fundamental frequency f_{c} based on the fundamental frequency f_{c}.

The filter processing unit 144 performs the filter processing on the first measurement data using the filter selected by the filter selection unit 147 to generate the second measurement data. The filter processing unit 144 performs the filter processing on the first measurement data using the high-pass filter or the band-pass filter selected by the filter selection unit 147. That is, the filter processing unit 144 performs the processing of the filter processing step S40 in FIG. 31.

Other functions of the measurement apparatus 1 in the second embodiment are the same as those in the first embodiment, and description thereof will be omitted.

According to the measurement method in the second embodiment described above, the same functions and effects as those in the measurement method in the first embodiment can be obtained.

### 3. Modifications

The disclosure is not limited to the embodiments, and various modifications can be made within the scope of the gist of the disclosure.

For example, in each of the above embodiments, each sensor 2 is provided at the main girder G of the superstructure 7, and alternatively, the sensor 2 may be provided at the surface of or inside the superstructure 7, at a lower surface of the deck slab F or the bridge pier 8a.

In the embodiments described above, the sensor 2 that is the observation apparatus is the acceleration sensor that outputs the acceleration data, and alternatively, the observation apparatus may be a speed sensor. When the observation apparatus is the speed sensor, the measurement apparatus 1 may perform the same filter processing as in each embodiment described above on the first measurement data based on speed data that is the observation data output from the speed sensor, and then perform the integration processing to calculate displacement.

The above embodiments and modifications are examples, and the disclosure is not limited thereto. For example, the embodiments and modifications may be combined as appropriate.

The disclosure includes configurations that are substantially identical to the configurations described in the embodiments, such as configurations where functions, methods, and results are the same, or configurations that achieve the same objects and effects. The disclosure includes configurations obtained by replacing non-essential portions of the configurations described in the embodiments. The disclosure includes configurations that can obtain the same functions and effects and configurations that can achieve the same object as the configurations described in the embodiments. The disclosure includes configurations obtained by adding known techniques to the configurations described in the embodiments.

The following contents are derived from the embodiments and the modifications described above.

An aspect of a measurement method includes:
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.

Using this measurement method, the second measurement data is generated by performing the filter processing on the first measurement data based on the observation data using the filter having the passband variably set according to the fundamental frequency of the deflection repeatedly generated at the bridge due to the traveling of the railway vehicle. Therefore, using this measurement method, even when the fundamental frequency changes depending on a passing time for the railway vehicle to pass the bridge, the number of cars of the railway vehicle, a bridge length, and the like, it is possible to generate the second measurement data in which an offset error and a noise component are effectively attenuated using an appropriate filter corresponding thereto. Therefore, according to this measurement method, it is possible to reduce drift caused by performing the integration processing on the second measurement data.

An aspect of the measurement method may further include:
a filter generation step of generating the filter having the passband variably set based on the fundamental frequency.

An aspect of the measurement method may further include:
a filter selection step of selecting, based on the fundamental frequency information on a plurality of filters stored in a storage unit and having passbands different from each other, the filter to be used in the filter processing from the plurality of filters.

In one aspect of the measurement method,
the filter may be a high-pass filter, and
a cutoff frequency of the filter may be higher than half of the fundamental frequency and lower than the fundamental frequency.

According to this measurement method, since it is possible to generate the second measurement data in which at least the noise component having the frequency equal to or lower than half of the fundamental frequency is attenuated, it is possible to reduce the drift and the low-frequency noise component generated due to the integration processing on the second measurement data.

In an aspect of the measurement method,
the filter may be a band-pass filter,
a first cutoff frequency of the filter may be higher than half of the fundamental frequency and lower than the fundamental frequency, and
a second cutoff frequency higher than the first cutoff frequency of the filter may be higher than n times the fundamental frequency and lower than n+1 times the fundamental frequency with respect to a predetermined integer n of 2 or more.

According to this measurement method, since it is possible to generate the second measurement data in which at least the noise component having the frequency equal to or lower than half of the fundamental frequency is attenuated, it is possible to reduce the drift and the low-frequency noise component generated due to the integration processing on the second measurement data. According to this measurement method, since it is possible to generate the second measurement data in which at least the noise component having the frequency equal to or higher than n+1 times the fundamental frequency is attenuated, it is possible to reduce the high-frequency noise component generated due to the integration processing on the second measurement data with a signal component having the fundamental frequency and second to n-th harmonic signal components thereof serving as measurement targets.

In an aspect of the measurement method,
the observation apparatus may be an acceleration sensor provided at the bridge.

In an aspect of the measurement method,
the second measurement data may be acceleration data, and
in the integration processing step, speed data may be generated as the third measurement data by integrating the second measurement data, or displacement data may be generated as the third measurement data by performing double integration on the second measurement data.

According to this measurement method, it is possible to reduce the drift and the low-frequency noise component generated in the speed data or the displacement data by performing the integration processing on the second measurement data that is the acceleration data.

In an aspect of the measurement method,
the fundamental frequency calculation step may include
   calculating frequency spectrum of the first measurement data, and
   calculating the fundamental frequency based on the frequency spectrum.

According to this measurement method, it is possible to accurately calculate the fundamental frequency even though a calculation load is high since the fast Fourier transform is performed.

In an aspect of the measurement method, the fundamental frequency calculation step may include
calculating, based on the first measurement data, a passing time that is a time required for the railway vehicle to pass the bridge, and
calculating the fundamental frequency based on the number of cars of the railway vehicle, a length of each of the cars of the railway vehicle, and a length of the bridge which are contained in environmental information created in advance, and the passing time.

According to this measurement method, since it is not necessary to perform the fast Fourier transform, the fundamental frequency can be calculated with a low load.

In an aspect of the measurement method,
the fundamental frequency calculation step may include
   calculating the number of cycles of the response based on the first measurement data,
   calculating, based on the first measurement data, a passing time that is a time required for the railway vehicle to pass the bridge, and
   calculating the fundamental frequency based on the number of cycles of the response and the passing time.

According to this measurement method, since it is not necessary to perform the fast Fourier transform, the fundamental frequency can be calculated with a low load.

An aspect of a measurement apparatus includes:
an observation data acquisition unit configured to acquire observation data output from an observation apparatus that observes an observation point of a bridge, the observation data including a response to an action of a railway vehicle traveling on the bridge on the observation point;
a fundamental frequency calculation unit configured to calculate, based on first measurement data based on the observation data, a fundamental frequency of deflection repeatedly generated at the bridge due to the traveling of the railway vehicle;
a filter processing unit configured to perform filter processing on the first measurement data using a filter having a passband variably set according to the fundamental frequency to generate second measurement data; and
an integration processing unit configured to perform integration processing on the second measurement data to generate third measurement data.

This measurement apparatus generates the second measurement data by performing the filter processing on the first measurement data based on the observation data using the filter having the passband variably set according to the fundamental frequency of the deflection repeatedly generated at the bridge due to the traveling of the railway vehicle. Therefore, this measurement apparatus can generate, even when the fundamental frequency changes depending on the passing time for the railway vehicle to pass the bridge, the number of cars of the railway vehicle, the bridge length, and the like, the second measurement data in which the offset error and the noise component are effectively attenuated using an appropriate filter corresponding thereto. Therefore, according to this measurement apparatus, it is possible to reduce drift caused by performing the integration processing on the second measurement data.

An aspect of a measurement system includes:
the aspect of the measurement apparatus; and
the observation apparatus.

An aspect of a non-transitory computer-readable storage medium storing a measurement program causes a computer to execute
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.

Using this measurement program, the computer generates the second measurement data by performing the filter processing on the first measurement data based on the observation data using the filter having the passband variably set according to the fundamental frequency of the deflection repeatedly generated at the bridge due to the traveling of the railway vehicle. Therefore, the computer can generate, even when the fundamental frequency changes depending on the passing time for the railway vehicle to pass the bridge, the number of cars of the railway vehicle, the bridge length, and the like, the second measurement data in which the offset error and the noise component are effectively attenuated using an appropriate filter corresponding thereto. Therefore, according to this measurement program, the computer can reduce drift caused by performing the integration processing on the second measurement data.

What is claimed is:

1. A measurement method comprising:
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.

2. The measurement method according to claim 1, further comprising:
a filter generation step of generating the filter having the passband variably set based on the fundamental frequency.

3. The measurement method according to claim 1, further comprising:
a filter selection step of selecting, based on the fundamental frequency and information on a plurality of filters stored in a storage unit and having passbands different from each other, the filter to be used in the filter processing from the plurality of filters.

4. The measurement method according to claim 1, wherein
the filter is a high-pass filter, and
a cutoff frequency of the filter is higher than half of the fundamental frequency and lower than the fundamental frequency.

5. The measurement method according to claim 1, wherein
the filter is a band-pass filter,
a first cutoff frequency of the filter is higher than half of the fundamental frequency and lower than the fundamental frequency, and
a second cutoff frequency higher than the first cutoff frequency of the filter is higher than n times the fundamental frequency and lower than n+1 times the fundamental frequency with respect to a predetermined integer n of 2 or more.

6. The measurement method according to claim 1, wherein
the observation apparatus is an acceleration sensor provided at the bridge.

7. The measurement method according to claim 1, wherein
the second measurement data is acceleration data, and
in the integration processing step, speed data is generated as the third measurement data by integrating the second measurement data, or displacement data is generated as the third measurement data by performing double integration on the second measurement data.

8. The measurement method according to claim 1, wherein
the fundamental frequency calculation step includes
calculating frequency spectrum of the first measurement data, and
calculating the fundamental frequency based on the frequency spectrum.

9. The measurement method according to claim 1, wherein
the fundamental frequency calculation step includes
calculating, based on the first measurement data, a passing time that is a time required for the railway vehicle to pass the bridge, and
calculating the fundamental frequency based on the number of cars of the railway vehicle, a length of each of the cars of the railway vehicle, and a length of the bridge which are contained in environmental information created in advance, and the passing time.

10. The measurement method according to claim 1, wherein
the fundamental frequency calculation step includes
calculating the number of cycles of the response based on the first measurement data,
calculating, based on the first measurement data, a passing time that is a time required for the railway vehicle to pass the bridge, and
calculating the fundamental frequency based on the number of cycles of the response and the passing time.

11. A measurement apparatus comprising:
an observation data acquisition unit configured to acquire observation data output from an observation apparatus that observes an observation point of a bridge, the observation data including a response to an action of a railway vehicle traveling on the bridge on the observation point;
a fundamental frequency calculation unit configured to calculate, based on first measurement data based on the observation data, a fundamental frequency of deflection repeatedly generated at the bridge due to the traveling of the railway vehicle;
a filter processing unit configured to perform filter processing on the first measurement data using a filter having a passband variably set according to the fundamental frequency to generate second measurement data; and
an integration processing unit configured to perform integration processing on the second measurement data to generate third measurement data.

12. A measurement system comprising:
the measurement apparatus according to claim 11; and
the observation apparatus.

13. A non-transitory computer-readable storage medium storing a measurement program, the measurement program causing a computer to execute
an observation data acquisition step of acquiring observation data output from an observation apparatus that observes an observation point of a bridge, the observation data including a response to an action of a railway vehicle traveling on the bridge on the observation point;
a fundamental frequency calculation step of calculating, based on first measurement data based on the observation data, a fundamental frequency of deflection repeatedly generated at the bridge due to the traveling of the railway vehicle;
a filter processing step of performing filter processing on the first measurement data using a filter having a passband variably set according to the fundamental frequency to generate second measurement data; and
an integration processing step of performing integration processing on the second measurement data to generate third measurement data.
